(19) United States
(12) Patent Application Publication
(10) Pub. No.: US 2007/0174293 A1
(43) Pub. Date: Jul. 26, 2007

(54) File printing method and system using e-mail

(75) Inventors: Hong-seock Kim, Seoul (KR); Jun Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/529,498

(22) Filed: Sep. 29, 2006

(30) Foreign Application Priority Data
Jan. 7, 2006 (KR) 2006-0002037

(51) Int. Cl. G06F 17/30

(52) U.S. Cl. 707/10

(57) ABSTRACT

Provided is a file printing method and system using e-mail. The method includes transmitting a file to a document server; transmitting an e-mail to a printing device through an e-mail server, the e-mail containing link information of the file transmitted; and retrieving the file from the document server using the link information and printing the retrieved file. Accordingly, a large print file can be printed regardless of the size of a file. In addition, since user authentication is performed every time a print file is downloaded, security is improved.

### CROSS-REFERENCE TO RELATED PATENT APPLICATION

This application claims the benefit under 35 U.S.C. §119(a) of Korean Patent Application No. 10-2006-0002037, filed on Jan. 7, 2006, in the Korean Intellectual Property Office, the entire disclosure of which is hereby incorporated by reference.

### BACKGROUND OF THE INVENTION

1. Field of the Invention

The present invention relates to a file printing method and system using e-mail. More particularly, the present invention relates to a file printing method and system using e-mail, by which when a printing job is performed in a printing device supporting printing of e-mail, the limitation of the file size attached to the e-mail is overcome, and security of the files is improved.

2. Description of the Related Art

According to a conventional printing technique using e-mail, a user transmits a file to be printed to a printing device through an e-mail, and then, the printing device prints the received file. The file to be printed is attached to the e-mail.

When the user transmits the email comprising the file to be printed, the transmitted e-mail is temporarily stored in a mail server. When the printing device accesses the mail server and requests the e-mail to be printed, the mail server transmits the stored e-mail to the printing device. The printing device then prints the file included in the received e-mail.

However, since the print file is transmitted as an attached file of the e-mail, and the capacity of a receive mail server used by a printing device is limited (in general, around 10 MB), a large print file cannot be printed.

In addition, since a malicious user may engage in sniffing (a kind of hacking: eavesdropping of an ID and password of a system user) of an e-mail having an attached print file, the security of the print file cannot be guaranteed.

Accordingly, there is a need for an improved file printing method and system using e-mail for printing that allows for large printing regardless of the file size of the attached file and increases the security of the print file.

### SUMMARY OF THE INVENTION

Exemplary embodiments of the present invention address at least the above problems and/or disadvantages and provide at least the advantages described below. Accordingly, an aspect of the present invention is to provide a file printing method and system using e-mail for printing a large print file regardless of the amount of an attached file.

According to an aspect of an exemplary embodiment of the present invention, there is provided a file printing method using e-mail, the method comprising transmitting a file to a document server; transmitting an e-mail to a printing device through an e-mail server, the e-mail containing link information of the file transmitted; and retrieving the file from the document server using the link information and printing the retrieved file.

According to another aspect of an exemplary embodiment of the present invention, there is provided a file printing system using e-mail, the system comprising a client for transmitting a file; a document server for receiving and storing the file; a printing device for printing the file; and an e-mail server for receiving an e-mail containing link information of the file transmitted to the document server from the client and transmitting the e-mail to the printing device, wherein the printing device receives the file from the document server corresponding to the link information and prints the received file.

According to yet another aspect of an exemplary embodiment of the present invention, there is provided a computer-readable medium having embodied thereon a computer program for the method of file printing using e-mail. The method comprises transmitting a file to a document server; transmitting an e-mail to a printing device through an e-mail server, the e-mail containing link information of the file transmitted to the document server; and retrieving the file from the document server using the link information and printing the retrieved file.

According to still another aspect of an exemplary embodiment of the present invention, there is provided a printing device for use with e-mail. The printing device comprises an interface unit for receiving an e-mail comprising one of an attached file and link information of a remotely stored file, and for retrieving the remotely store file according to the link information if the link information is link information of a remotely stored file to be printed; an attached file examiner for determining whether the email comprises a attached file or link information of a remotely stored file; and a printing unit for printing one of the attached file and the retrieved file.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a flowchart illustrating a file printing method using e-mail according to an exemplary embodiment of the present invention;

FIG. 2 illustrates an e-mail containing link information of a document server according to an exemplary embodiment of the present invention;

FIG. 3 is a detailed flowchart illustrating operation 16 of FIG. 1;

FIG. 4 is a detailed flowchart illustrating operation 18 of FIG. 1; and

FIG. 5 is a block diagram of a file printing system using e-mail according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will now be described more fully with reference to the accompanying drawings, in which exemplary embodiments of the invention are shown.

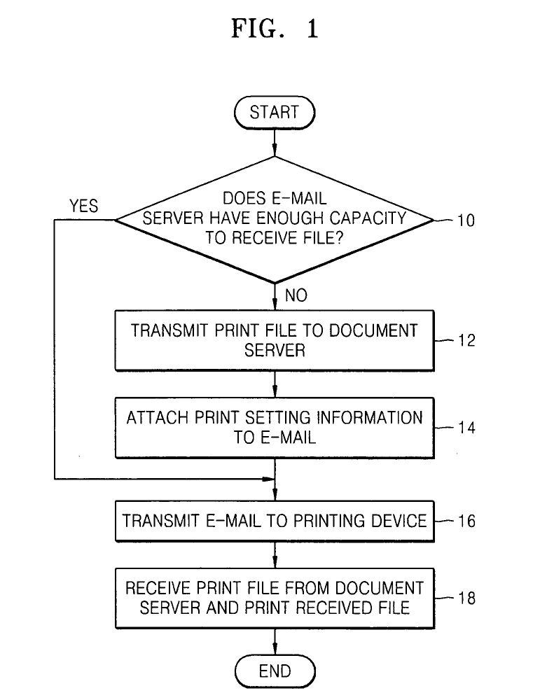

FIG. 1 is a flowchart illustrating a file printing method using e-mail according to an exemplary embodiment of the present invention.

Referring to FIG. 1, in operation 10, it is determined whether an e-mail server can receive a file.

Whether the e-mail server can receive a file can be determined by determining whether the e-mail server has enough capacity to receive the file. If the e-mail server does not have enough capacity to receive the file, the e-mail server cannot receive the file even if the file is attached to an e-mail and transmitted to the e-mail server.

If the e-mail server can receive the file, the process proceeds to operation 16.

However, if the e-mail server cannot receive the file, in operation 12, the file is transmitted to a document server.

The document server is a high capacity server for storing files. The document server forms a network with a client for transmitting the file. The document server also forms a network with a printing device.

For example, if the e-mail server does not have enough capacity to receive the file, the file is transmitted to the document server, which can store the file.

In operation 14, print setting information of the file is attached to an e-mail. The print setting information attached to the e-mail includes header information, operating code, or a specific character stream, which is defined for a printing job between a client transmitting a file and a printing device.

The print setting information is used as information to perform a printing job of the e-mail containing the print setting information by using a procedure of determining whether the received file is a file to be printed.

However, since the procedure of attaching the print setting information of the file to the e-mail is not required, this process can proceed to operation 16 after operation 12 without performing operation 14. In this case, the print setting information of the file is not attached to an e-mail.

In operation 16, the email is transmitted to the printing device through the e-mail server. If it is determined in operation 12 that the e-mail server cannot receive the file, the e-mail contains link information of the file that was transmitted to the document server and may include the print setting information of operation 14. The link information of the file indicates a network address of the document server. If it is determined in operation 12 that the e-mail server can receive the file, the email contains the attached file to be printed.

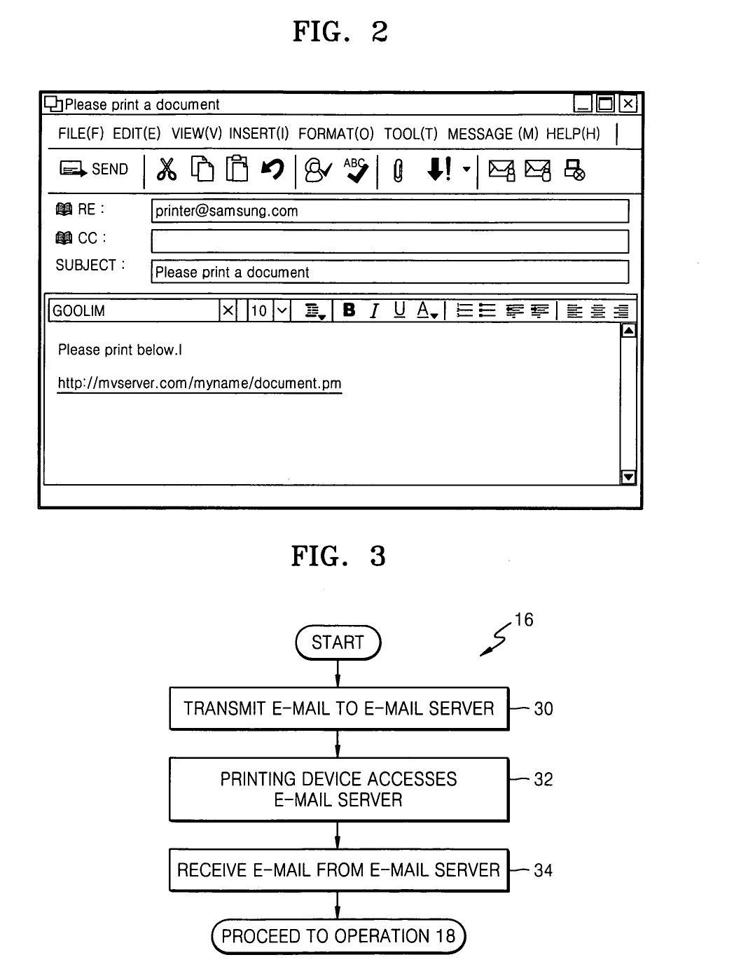

FIG. 2 illustrates the e-mail containing the link information of the file. As illustrated in FIG. 2, the e-mail containing the link information is transmitted to the printing device through the e-mail server with or without the print setting information.

FIG. 3 is a detailed flowchart illustrating operation 16 of FIG. 1.

Referring to FIG. 3, in operation 30, the e-mail containing the link information is transmitted to the e-mail server.

In operation 32, the printing device accesses the e-mail server. The printing device periodically accesses the e-mail server and requests an e-mail to be transmitted thereto.

In operation 34, the printing device receives the e-mail from the e-mail server. If the e-mail server has an e-mail to be transmitted to the printing device, the e-mail server transmits the e-mail to the printing device. The printing device receives the e-mail from the e-mail server.

Referring back to FIG. 1, in operation 18, the file to be printed is received and printed. The file to be printed may be received from the email server or the document server corresponding to the link information. In particular, if the file to be printed is received from the document server, whether the received file is printed may be determined using the print setting information.

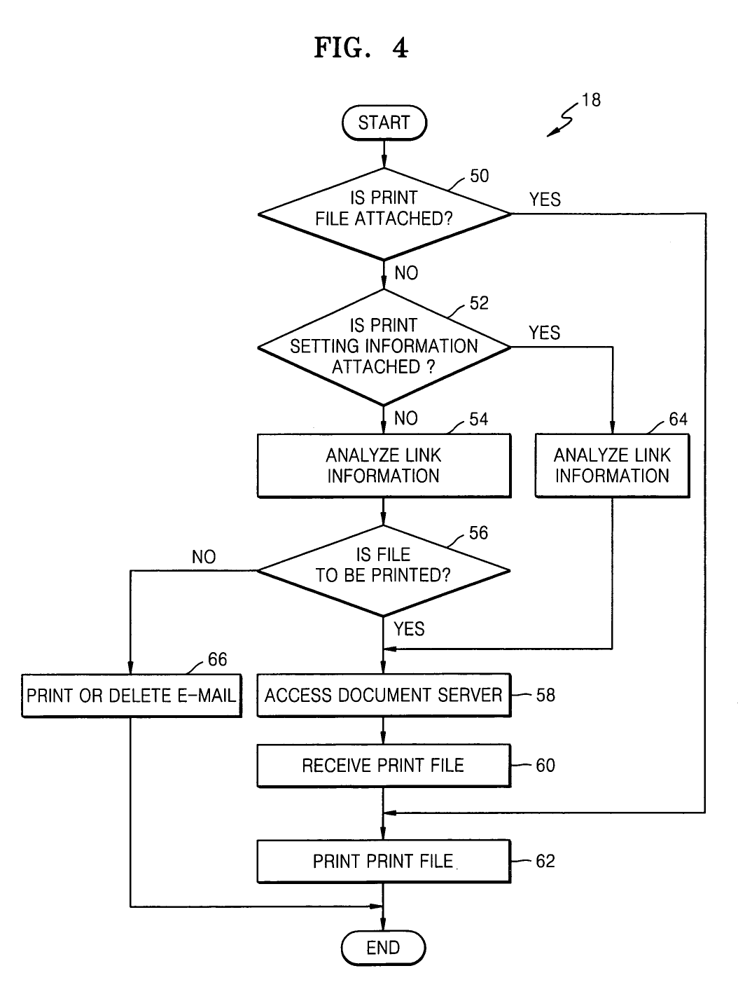

FIG. 4 is a detailed flowchart illustrating operation 18 of FIG. 1.

Referring to FIG. 4, in operation 50, it is determined whether the file is attached to the e-mail received from the e-mail server.

If the file is attached to the e-mail, the attached file is printed.

If the file is not attached to the e-mail, in operation 52, it is determined whether the print setting information of the file is attached to the e-mail.

If the print setting information is not attached to the e-mail, in operation 54, the link information contained in the e-mail is analyzed. For example, if the e-mail illustrated in FIG. 2 is received, the link information corresponding to the content of the e-mail is analyzed.

In operation 56, it is determined whether the received file is a file to be printed using the analyzed link information. That is, it is determined whether the analyzed link information (network address) is for spam mail or is link information not to be printed.

If the received file is a file to be printed, in operation 58, the printing device accesses the document server corresponding to the analyzed link information.

In operation 60, the file is received from the document server.

An authentication procedure may be performed before the file is received from the document server.

In operation 62, the received file is printed.

If the print setting information of the file is attached to the e-mail in operation 52, in operation 64, the link information contained the e-mail is analyzed. The fact that the print setting information is attached to the e-mail indicates that the file stored in the document server corresponding to the link information contained in the e-mail is a file to be printed.

Thus, operations 58, 60, and 62 are performed after operation 64. That is, if the print setting information is attached to the e-mail, operations 58, 60, and 62 are directly performed without performing operation 56.

If the received file is not a file to be printed in operation 56, in operation 66, the printing device prints or deletes the received e-mail.

That is, although the printing device has received the e-mail, if the file attached to the e-mail is not a file to be printed as indicated by the result of the analysis of the link information contained in the e-mail, the user can select whether the e-mail is deleted or if only the e-mail itself is printed.

The exemplary embodiments of the present invention can be written as codes/instructions/programs and can be implemented in general-use digital computers that execute the codes/instructions/programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion. Also, functional programs, codes, and code segments for accomplishing the exemplary embodiments of present invention can be easily construed by programmers skilled in the art to which the exemplary embodiments of the present invention pertains.

A file printing system using e-mail according to an exemplary embodiment of the present invention will now be described in detail with reference to the accompanying drawing.

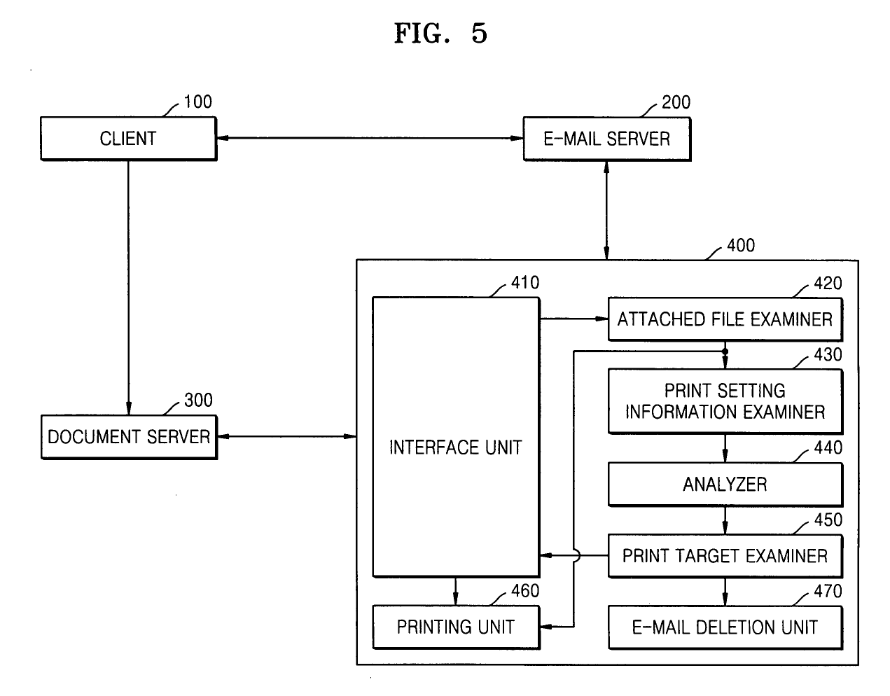

FIG. 5 is a block diagram of a file printing system using e-mail according to an exemplary embodiment of the present invention. Referring to FIG. 5, the file printing system includes a client 100, an e-mail server 200, a document server 300, and a printing device 400.

The client 100 may determine whether the e-mail server 200 can receive a file. For example, the client 100 determines whether the e-mail server 200 has enough capacity to receive a print file.

If the e-mail server 200 can receive the file, the client 100 attaches the file to an e-mail and transmits the e-mail to the e-mail server 200. If the e-mail server 200 cannot receive the file, the client 100 transmits the file to the document server 300.

The document server 300 receives the file from the client 100 and stores the received file. When the document server 300 receives a request for transmitting the file from the printing device 400, the document server 300 transmits the file to the printing device 400. To do this, the document server 300 comprises a mass storage space for storing files, forms a network with the client 100 transmitting the file, and also forms a network with the printing device 400.

After storing the file in the document server 300, the client 100 transmits an e-mail containing link information of the file to the printing device 400 through the e-mail server 200.

The link information contained in the e-mail may link the document server 300 with the printing device 400.

The client 100 may attach print setting information to the e-mail. The print setting information attached to the e-mail includes header information, operating code, or a specific character stream, which is defined for a printing job between a client transmitting a file and a printing device.

The e-mail server 200 receives the e-mail containing the link information from the client 100 and transmits the received e-mail to the printing device 400.

The printing device 400 accesses the e-mail server 200 and receives the e-mail from the e-mail server 200.

The printing device 400 receives the file from the document server 300 corresponding to the link information contained in the e-mail and prints the received file.

To do this, the printing device 400 includes an interface unit 410, an attached file examiner 420, a print setting information examiner 430, an analyzer 440, a print target examiner 450, a printing unit 460, and an e-mail deletion unit 470.

The interface unit 410 receives the e-mail containing the link information from the e-mail server 200 and outputs the received e-mail to the attached file examiner 420.

The attached file examiner 420 determines whether the file is attached to the received e-mail. If the file is not attached to the received e-mail, the attached file examiner 420 outputs the determination result to the print setting information examiner 430.

If the file is attached to the received e-mail, the attached file examiner 420 outputs the determination result to the printing unit 460.

The print setting information examiner 430 determines whether the print setting information of the file is attached to the received e-mail in response to the attached file examiner 420 determining that the file is not attached to the received e-mail, and outputs the determination result to the analyzer 440.

The print setting information attached to the e-mail includes header information, operating code, or a specific character stream, which is defined for a printing job between a client transmitting a file and a printing device.

The print setting information is used as information to perform a printing job of the e-mail containing the print setting information by using a procedure of determining whether the received file is a file to be printed.

The analyzer 440 analyzes the link information contained in the e-mail according to the determination result of the print setting information examiner 430 and outputs the analysis result to the print target examiner 450.

The print target examiner 450 determines whether the file is a file to be printed according to the analysis result of the analyzer 440. That is, the print target examiner 450 determines whether the analyzed link information is spam mail or link information not to be printed.

If the file is a file to be printed, the print target examiner 450 outputs the determination result to the interface unit 410.

If the file is not a file to be printed, the print target examiner 450 outputs the determination result to the e-mail deletion unit 470.

The interface unit 410 accesses the document server 300 corresponding to the link information according to the determination result of the print target examiner 450, which indicates that the file is a file to be printed. The interface unit 410 receives the file from the document server 300 and outputs the received file to the printing unit 460.

An authentication procedure is performed before the file is received from the document server 300.

The printing unit 460 prints the file received from the interface unit 410. When the file is attached to the e-mail, the printing unit 460 prints the file attached to the e-mail in response to the determination result of the attached file examiner 420.

The e-mail deletion unit 470 deletes the e-mail according to the determination result of the print target examiner 450, when the file is not a file to be printed.

As described above, by a file printing method and apparatus according to exemplary embodiments of the present invention, a large print file can be printed regardless of the size of an attached file.

In addition, since a printing device automatically performs a printing job through a link in an e-mail, user convenience can be increased.

In addition, since user authentication is performed every time a print file is downloaded to prevent information from being leaked by malicious sniffing of e-mail, security is improved.

While certain exemplary embodiments of the invention has have been shown and described hereinwith reference to a certain preferred embodiments thereof, it will be understood by those skilled in the art that various changes in form and details may be made therein without departing from the spirit and scope of the invention as defined by the appended claims and their equivalents.

What is claimed is:

1. A file printing method using e-mail, the method comprising:
(a) transmitting a file to a document server;
(b) transmitting an e-mail to a printing device through an e-mail server, the e-mail containing link information of the file transmitted to the document server; and
(c) retrieving the file from the document server using the link information and printing the retrieved file.

2. The method of claim 1, further comprising (d) determining whether the e-mail server can receive the file.

3. The method of claim 2, wherein in operation (d), it is determined whether the e-mail server has enough capacity to receive the file.

4. The method of claim 1, wherein in operation (b), print setting information of the file is added to the e-mail.

5. The method of claim 4, wherein the print setting information is one of header information, operating code, or a specific character stream.

6. The method of claim 1, wherein operation (b) comprises:
transmitting the e-mail to the e-mail server;
the printing device accessing the e-mail server; and
the printing device receiving the e-mail from the e-mail server.

7. The method of claim 1, wherein in operation (c), it is determined whether the file is a file to be printed using the link information or print setting information of the file.

8. The method of claim 1, wherein in operation (c), if the file is not a file to be printed, the e-mail is deleted.

9. A computer-readable medium having embodied thereon a computer program for the method of file printing using e-mail, the method comprising:
(a) transmitting a file to a document server;
(b) transmitting an e-mail to a printing device through an e-mail server, the e-mail containing link information of the file transmitted to the document server; and
(c) retrieving the file from the document server using the link information and printing the retrieved file.

10. A file printing system using e-mail, the system comprising:
a client for transmitting a file;
a document server for receiving and storing the file;
a printing device for printing the file; and
an e-mail server for receiving an e-mail containing link information of the file transmitted to the document server from the client and transmitting the e-mail to the printing device,
wherein the printing device receives the file from the document server corresponding to the link information and prints the received file.

11. The system of claim 10, wherein the client determines whether the e-mail server can receive the file.

12. The system of claim 11, wherein the client determines whether the e-mail server has enough capacity to receive the file.

13. The system of claim 10, wherein the client adds print setting information of the file to the e-mail.

14. The system of claim 13, wherein the print setting information is one of header information, operating code, or a specific character stream.

15. The system of claim 10, wherein the printing device accesses the e-mail server and receives the e-mail from the e-mail server.

16. The system of claim 10, wherein the printing device determines whether the file is a file to be printed using the link information or print setting information of the file.

17. The system of claim 10, wherein the printing device deletes the e-mail according to a determination result indicating that the file is not a file to be printed.

18. A printing device for use with e-mail, the printing device comprising:
an interface unit for receiving an e-mail comprising one of an attached file and link information of a remotely stored file, and for retrieving the remotely store file according to the link information if the link information is link information of a remotely stored file to be printed;
an attached file examiner for determining whether the email comprises a attached file or link information of a remotely stored file; and
a printing unit for printing one of the attached file and the retrieved file.

19. The printing device of claim 18, wherein the printing device further comprises:
a print target examiner for determining whether the file is a file to be printed, if the attached file examiner determines that the e-mail comprises link information of a remotely stored file, wherein if it is determined that the file is to be printed the result of the determination is output to the interface unit.

20. The printing device of claim 19, wherein the printing device further comprises:
an analyzer for analyzing the link information contained in the e-mail, if the attached file examiner determines that the e-mail comprises link information of a remotely stored file, and providing a result of the analysis to the print target examiner.

21. The printing device of claim 20, wherein the printing device further comprises:
a print setting information examiner for determining whether print setting information comprised is attached to the e-mail in response to the attached file examiner determining that the file is not attached to the e-mail, and outputs the determination result to the analyzer.

22. The printing device of claim 19, wherein the printing device further comprises:
an e-mail deletion unit for deleting the email if the print target examiner determines that the file is not to be printed.
